(19) United States
(12) Patent Application Publication
(10) Pub. No.: US 2024/0256729 A1
(43) Pub. Date: Aug. 1, 2024

(54) METHOD AND SYSTEM FOR DETERMINING MODEL OUTPUT DIRECTION ON BASIS OF HEAT DISSIPATION CHARACTERISTIC ANALYSIS FOR STABILIZING OUTPUT OF METAL 3D PRINTING

(71) Applicant: Korea Electronics Technology Institute, Seongnam-si (KR)

(72) Inventors: Hwa Seon SHIN, Yongin-si (KR); Sung Hwan CHUN, Seoul (KR); Hye In LEE, Anyang-si (KR); Jae Ho SHIN, Hanam-si (KR); Sung Hun PARK, Seoul (KR)

(73) Assignee: Korea Electronics Technology Institute, Seongnam-si (KR)

(21) Appl. No.: 18/565,797

(22) PCT Filed: May 25, 2022
(86) PCT No.: PCT/KR2022/007388

§ 371 Date: Nov. 30, 2023

(30) Foreign Application Priority Data
May 31, 2021 (KR) 10-2021-0069909

(51) Int. Cl. G06F 30/17

(52) U.S. Cl. CPC G06F 30/17

(57) ABSTRACT

Provided are a method and a system for determining a model output direction on the basis of heat dissipation characteristic analysis for stabilizing output of metal 3D printing. A method for determining a model output direction on the basis of heat dissipation characteristic analysis according to an embodiment of the present invention comprises: a shape characteristic parameter deriving step in which a model output direction determining system calculates model shape characteristic data according to the output direction of a model that changes in a metal 3D printing output process; a heat data change amount collecting step in which the model output direction determining system collects simulation results regarding residual heat data of the model every time the output direction changes; a heat data change amount analyzing step in which the model output direction determining system analyzes heat dissipation characteristics inside the model on the basis of the collected simulation results, thereby calculating heat flatness after heat dissipation with regard to each output direction; and an output direction determining step in which the model output direction determining system recommends output directions in descending order of heat flatness remaining in the model on the basis of the result of calculating heat flatness after heat dissipation with regard to each output direction in the heat data change amount analyzing step. Accordingly, the amount of remaining heat that changes depending on the output direction is measured through simulation, thereby analyzing heat dissipation characteristics of the model, and output directions appropriate for output stabilization are derived and are proposed to process workers, thereby contributing to output stabilization of metal 3D printing.

### TECHNICAL FIELD

The disclosure relates to a method and a system for determining a model output direction based on heat dissipation characteristic analysis for stabilizing output of metal 3D printing, and more particularly, to a method and a system for determining a model output direction based on heat dissipation characteristic analysis, which analyze an output direction showing an optimal heat dissipation characteristic by predicting a heat dissipation characteristic of a layer of a model through a simulation while outputting.

### BACKGROUND ART

The order of steps of using 3D printing output software is: ‘inputting a model; adjusting an output direction; generating a support; slicing; generating a tool path; and really outputting’.

In this case, all elements (a position and a volume of a support, a slicing cross section, a tool path) of subsequent steps may change according to which output direction a model is adjusted to, directly influencing output quality.

FIGS. 1A to 1C are views illustrating an example of a support which is generated after being changed according to a direction of a model, and FIGS. 2A and 2B are views illustrating a state in which a heat dissipation problem area occurs according to a direction of a model.

In the case of metal printing, metal powder coated along a tool path is melted by heat of 600-1600 degrees which is generated by lasers moving at high speed. High-temperature heat generated by movement of lasers should be discharged through a peripheral portion of a model or a support after melting metal powder. In this case, when heat does not dissipate, heat may cause an artifact in an output, resulting in output failure.

The red edge area of FIG. 1C lacks a horizontal heat dissipation area compared to the other areas of the model, and a distance by which heat should be transmitted to a bed through a support is so long that heat dissipation is retarded. In this case, output may fail due to a heat dissipation problem as shown in FIG. 2A.

In a related-art method, an output direction that results in good heat dissipation may be determined based on know-how of a process operator and morphological characteristics of a model (height, width, weight, center, etc.). However, in the related-art method, cost such as time, materials, manpower is continuously required to find an appropriate output direction, and, when an operator is superseded, an unexperienced process operator may have difficulty in making the same metal additive manufacturing output.

### DISCLOSURE

### Technical Problem

The disclosure has been developed in order to address the above-discussed deficiencies of the prior art, and an object of the disclosure is to provide a method and a system for determining a model output direction based on heat dissipation characteristic analysis for stabilizing output of metal 3D printing, which analyze a heat dissipation characteristic of a model by measuring an amount of residual heat, which changes according to an output direction, through a simulation, and then derive output directions appropriate for output stabilization, and recommend an output direction to a process operator.

Another object of the disclosure is to provide a method and a system for determining a model output direction based on heat dissipation characteristic analysis for stabilizing output of metal 3D printing, which provide a process operator with a rationale for determining an output direction appropriate for process stabilization to allow the process operator to determine an output direction considering a heat dissipation characteristic regardless of operators' skill.

### Technical Solution

According to an embodiment of the disclosure to achieve the above-described objects, a heat dissipation characteristic analysis-based model output direction determination method may include: a shape characteristic parameter deriving step of calculating, by a model output direction determination system, shape characteristic data of a model according to an output direction of the model which changes in an outputting process of metal 3D printing; a thermal data change amount collection step of collecting, by the model output direction determination system, simulation results regarding residual heat data of the model every time the output direction changes; a thermal data change amount analysis step of analyzing, by the model output direction determination system, heat dissipation characteristics within the model, based on the collected simulation results, and calculating heat flatness after heat dissipation with respect to each output direction; and an output direction determination step of recommending, by the model output direction determination system, output directions in descending order of heat flatness remaining within the model, based on the result of calculating heat flatness after heat dissipation with respect to each output direction at the thermal data change amount analysis step.

In addition, the shape characteristic parameter deriving step may include calculating shape characteristic data including a size of a support area, a volume of an outer box, a height, a center of gravity of the model with respect to each output direction according to a changing output direction.

According to an embodiment of the disclosure, the heat dissipation characteristic analysis-based model output direction determination method may further include an initial user setting step of setting, by the model output direction determination system, at least one rotation axis of an X-axis, a Y-axis, and a Z-axis as a reference rotation axis for analyzing according to a user input, and setting an output direction angle range and a unit angle which are to be analyzed.

In addition, the initial user setting step may include determining an amount of calculation for analyzing heat dissipation according to the number of reference rotation axes, a range of an angle, and a degree of a unit angle which are set.

In addition, the thermal data change amount collection step may include: a step of, when the output direction changes and a shape of an outer box changes, dividing an area of a lower end of the changed outer box by predetermined intervals, and then setting a divided area as an area responsible for discharging heat; a step of setting a center point of a divided area as a generation position of a temporary support for analyzing heat dissipation, and generating a temporary support at the set generation position; and a step of collecting thermal data simulation results of an output model.

In addition, the step of collecting the thermal data simulation results of the output model may include: a step of deriving thermal data of each layer within the heat discharge responsible area which is covered by each temporary support; a step of separating the model and the temporary support area; and a step of calculating a maximum residual heat data value and a minimum residual heat data value within an area.

In addition, the thermal data change amount analysis step may include: a step of generating a linear heat discharge graph based on the maximum residual heat data and the minimum residual heat data which are calculated within each heat discharge responsible area; a step of deriving feature points of each heat discharge range with reference to the generated linear heat discharge graph; a step of calculating differences between the derived feature points and the linear heat discharge graph; and a step of normalizing and adding the calculated differences according to each output direction.

In addition, the thermal data change amount analysis step may include comparing the results of normalizing and adding according to each output direction, and determining an output direction that has a relatively smaller value than the other output directions as an output direction having a relatively good heat dissipation characteristic.

In addition, the thermal data change amount analysis step may include applying a weighting inputted by a user when deriving final analysis data for determining an output direction, and a result value (Value) of the final analysis data for determining the output direction may be calculated by Equation 4 presented below, when ThermalData is heat change amount analysis data, ModelFeature Data is shape characteristic data of a model, SupportArea is a size of a support area, OutBoxVolume is a volume of an outer box of a model, ModelHeight is a height of a model, CenterOfGravity is a center of gravity of a model, α, β, γ, δ, ω, θ are weightings that are given to respective shape characteristics, a final weighting (Wresult) is a sum of a first weighting (W1) and a second weighting (W2), the first weighting (W1) is defined by Equation 1 presented below, the second weighting (W2) is defined by Equation 2 presented below, and ModelFeatureData is defined by Equation 3 presented below:

$${W}_{1} = w + θ ( ∴ 0 \leq w , θ \leq 1 ) \qquad Equation 1$$

$${W}_{2} = α + β + γ + δ ( ∴ 0 \leq α , β , γ , δ \leq 1 ) \qquad Equation 2$$

$$ModelFeatureData = α SupportArea + β OutBoxVolume + γ ModelHeight + δ CenterOfGravity \qquad Equation 3$$

$$Value = wThermalData + θ ModelFeatureData . \qquad Equation 4$$

According to another embodiment of the disclosure, a heat dissipation characteristic analysis-based model output direction determination system may include: a processor configured to calculate shape characteristic data of a model according to an output direction of the model which changes in an outputting process of metal 3D printing, to collect simulation results for residual heat data of the model every time the output direction changes, to analyze heat dissipation characteristics within the model, based on the collected simulation results, to calculate heat flatness after heat dissipation with respect to each output direction, and to recommend output directions in descending order of heat flatness remaining in the model based on the result of calculating; and a screen output unit configured to output the result of recommending output directions to a screen.

According to still another embodiment of the disclosure, there is provided a computer-readable recording medium having a computer program recorded thereon to perform a heat dissipation characteristic analysis-based model output direction determination method, the method including: a shape characteristic parameter deriving step of calculating, by a model output direction determination system, shape characteristic data of a model according to an output direction of the model which changes in an outputting process of metal 3D printing; a thermal data change amount collection step of collecting, by the model output direction determination system, simulation results regarding residual heat data of the model every time the output direction changes; a thermal data change amount analysis step of analyzing, by the model output direction determination system, heat dissipation characteristics within the model, based on the collected simulation results, and calculating heat flatness after heat dissipation with respect to each output direction; and an output direction determination step of recommending, by the model output direction determination system, output directions in descending order of heat flatness remaining within the model, based on the result of calculating heat flatness after heat dissipation with respect to each output direction at the thermal data change amount analysis step.

According to yet another embodiment of the disclosure, a heat dissipation characteristic analysis-based model output direction determination method may include: a thermal data change amount collection step of collecting, by a model output direction determination system, simulation results regarding residual heat data of a model every time an output direction changes in an outputting process of metal 3D printing; a thermal data change amount analysis step of analyzing, by the model output direction determination system, heat dissipation characteristics within the model, based on the collected simulation results, and calculating heat flatness after heat dissipation with respect to each output direction; and an output direction determination step of recommending, by the model output direction determination system, output directions in descending order of heat flatness remaining within the model, based on the result of calculating heat flatness after heat dissipation with respect to each output direction at the thermal data change amount analysis step.

### Advantageous Effects

According to embodiments of the disclosure as described above, heat dissipation characteristics of a model may be analyzed by measuring an amount of remaining heat that changes according to an output direction through a simulation, and then, output directions appropriate for output stabilization may be derived and may be recommended to process operators, thereby contributing to output stabilization of metal 3D printing.

In addition, according to embodiments of the disclosure, dependency on a personal skill level of a process operator for determining an output direction, and an output direction optimized for process stabilization are selected by process operators, so that an output failure rate may be reduced and an additive manufacturing cost may be reduced.

### DESCRIPTION OF DRAWINGS

FIGS. 1A to 1C are views illustrating a support which is generated after being changed according to a direction of a model;

FIGS. 2A and 2B are views illustrating a state in which a heat dissipation problem area is generated according to a direction of a model;

FIG. 3 is a view provided to explain a method for determining a model output direction based on heat dissipation characteristic analysis according to an embodiment of the disclosure;

FIG. 4 is a view provided to explain a thermal data change amount collection step according to an embodiment of the disclosure;

FIG. 5 is a view provided to explain setting of a heat discharge responsible area according to an embodiment of the disclosure;

FIG. 6 is a view provided to explain a thermal data change amount analysis step in detail according to an embodiment of the disclosure;

FIG. 7 is a view illustrating a linear heat discharge graph according to an embodiment of the disclosure;

FIG. 8 is a view provided to explain a weighting which is applied when final analysis data for determining an output direction is derived according to an embodiment of the disclosure;

FIG. 9 is a view provided to explain a system for determining a model output direction based on heat dissipation characteristic analysis according to an embodiment of the disclosure; and

FIG. 10 is a view illustrating a screen which is outputted through a screen output unit according to an embodiment of the disclosure.

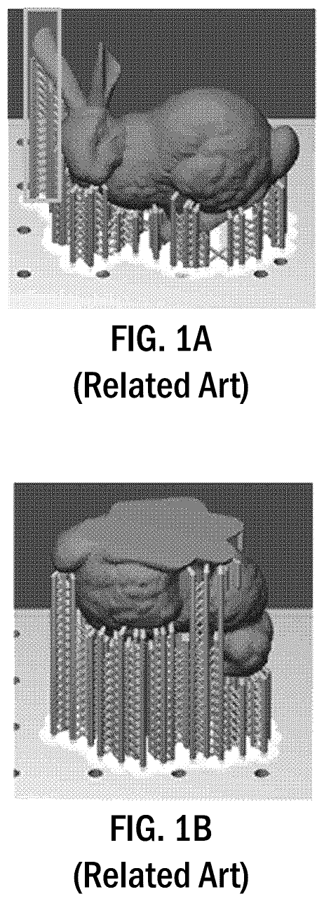

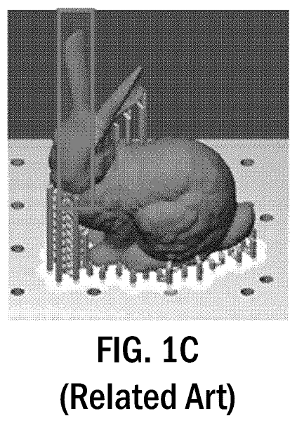

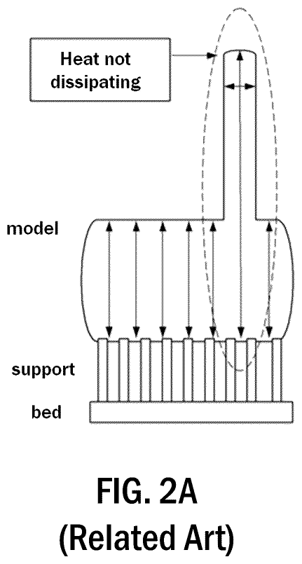

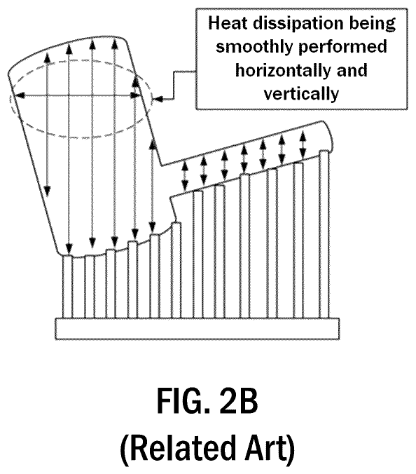

### BEST MODE

Hereinafter, the disclosure will be described in more detail with reference to the drawings.

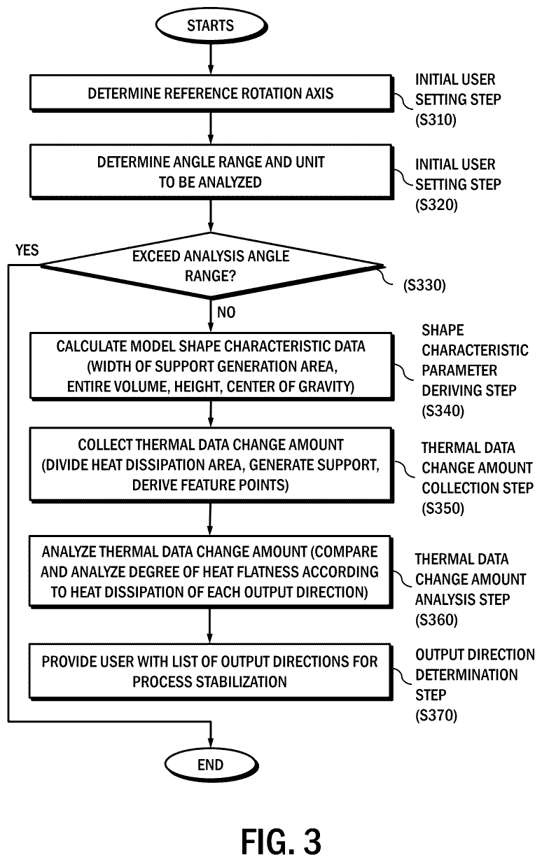

FIG. 3 is a view provided to explain a heat dissipation characteristic analysis-based model output direction determination method according to an embodiment of the disclosure.

The heat dissipation characteristic analysis-based model output direction determination method according to the present embodiment may be provided to analyze a heat dissipation characteristic of a model by measuring an amount of residual heat, which changes according to an output direction, through a simulation, and then to derive output directions appropriate for output stabilization, and to provide a process operator with an output direction and a rationale for determining an output direction.

Referring to FIG. 3, the heat dissipation characteristic analysis-based model output direction determination method may include an initial user setting step, a shape characteristic parameter deriving step, a thermal data change amount collection step, a thermal data change amount analysis step, and an output direction determination step.

At the initial user setting step, at least one rotation axis among an X-axis, a Y-axis, and a Z-axis may be set as a reference rotation axis for analyzing according to a user input (S310), and an output direction angle range and a unit angle which are to be analyzed may be set (S320).

In addition, at the initial user setting step, a weighting which is defined by a user may be inputted for a shape characteristic parameter, and an amount of calculation for analyzing heat dissipation may be determined according to the number of reference rotation axes, an angle range, and a degree of a unit angle which are set.

In addition, when the initial user setting step is completed, the heat dissipation characteristic analysis-based model output direction determination method may perform the shape characteristic parameter deriving step if a measured angle range does not exceed the analysis angle range (S330—No).

At the shape characteristic parameter deriving step, shape characteristic data of a model may be calculated according to an output direction of the model which changes in an outputting process of metal 3D printing (S340).

Specifically, since shape characteristics are also important according to an output purpose in determining an output direction, shape characteristic data including a size of a support area of the model, a volume of an outer box, height, the center of gravity of the model with respect to each output direction may be calculated according to a changing output direction at the shape characteristic parameter deriving step.

For example, at the shape characteristic parameter deriving step, a size of a support area, a volume of an outer box, height, the center of gravity which are representative shape characteristics of a model with respect to each output direction may be calculated, and then, may be applied when a final result for determining an output direction is derived according to a weighting inputted by a user.

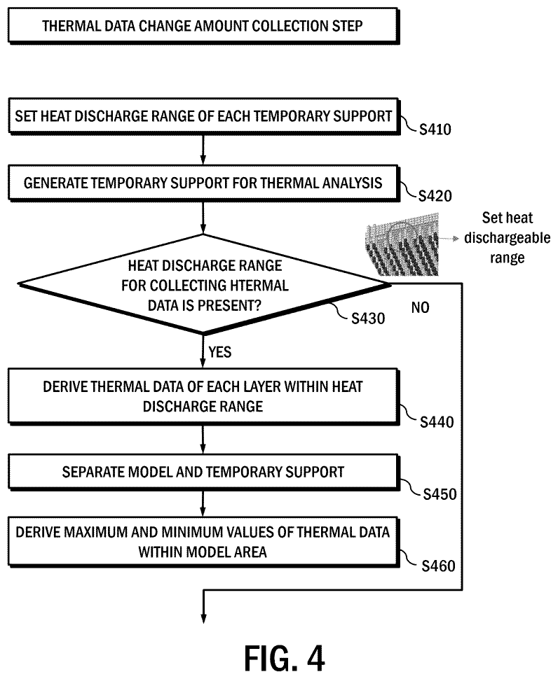

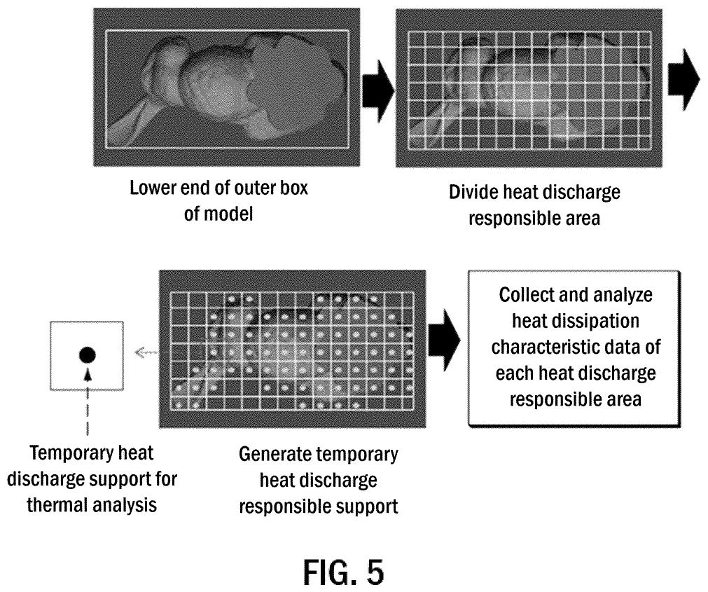

At the thermal data change amount collection step, simulation results regarding residual heat data of the model may be collected every time the output direction changes (S350). The thermal data change amount collection step will be described below in detail with reference to FIGS. 4 to 5.

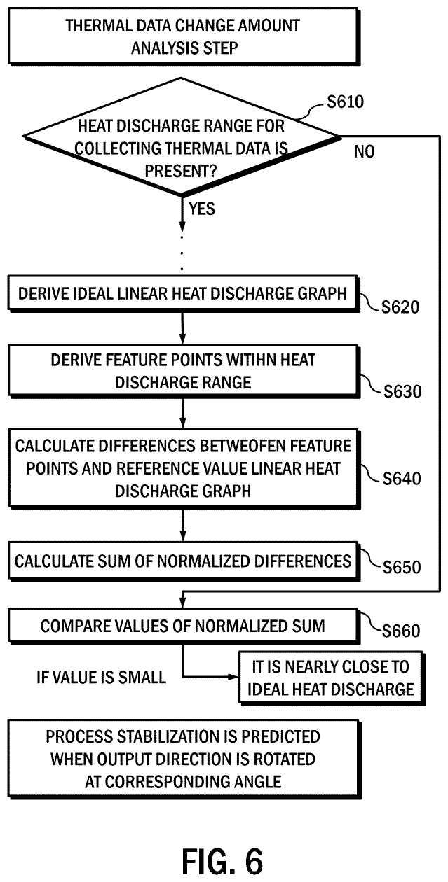

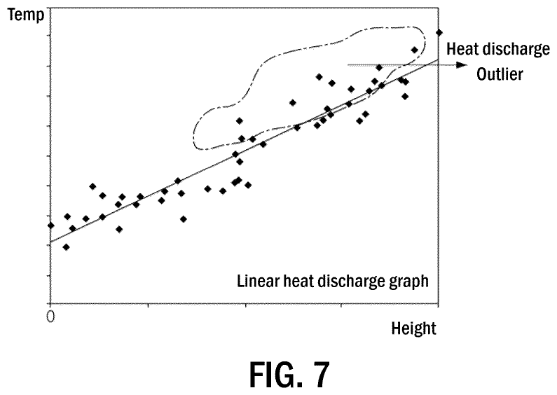

At the thermal data change amount analysis step, heat dissipation characteristics in the model may be analyzed based on the collected simulation results, and heat flatness after heat dissipation with respect to each output direction may be calculated based on the result of analyzing heat dissipation characteristics (S360). The thermal data change amount analysis step will be described below in detail with reference to FIGS. 6 and 7.

At the output direction determination step, output directions may be recommended in descending order of heat flatness remaining in the model, based on the result of calculating heat flatness after heat dissipation with respect to each output direction (S370).

For example, at the output direction determination step, an output direction that guarantees enhanced output stabilization may be derived based on the result of thermal data change amount analysis, which is derived at the previous step, and the model shape characteristic data applying a weighting inputted by a user, and finally, a list may be created with 5-10 output directions and may be provided to process operators.

In this case, a process operator may identify the provided output directions through a user operation, and may finally determine an output direction.

Through this process, an output direction may be determined by considering heat dissipation characteristics regardless of process operators' skill, so that an output failure rate may be reduced and a cost of additive manufacturing may be reduced.

FIG. 4 is a view provided to explain the thermal data change amount collection step in detail according to an embodiment of the disclosure, and FIG. 5 is a view provided to explain setting of a heat discharge responsible area according to an embodiment of the disclosure.

Referring to FIG. 4, when an output direction changes and thus a shape of an outer box of a model changes at the thermal data change amount collection step, an area of a lower end of the changed outer box may be divided by predetermined intervals as shown in FIG. 5, and divided areas may be set to heat discharge responsible areas (heat discharge range) (S410), and a center point of each of the divided areas may be set as a generation position of a temporary support for analyzing heat dissipation, and a temporary support may be generated at the set generation position (S420), and, when a heat dissipation range for collecting thermal data is present (S430—Yes), thermal data simulation results of the output model may be collected.

Specifically, the shape of the outer box of the model may change every time the output direction changes. Accordingly, at the thermal data change amount collection step, when the output direction changes and thus the shape of the outer box of the model changes, an area of a lower end of the changed outer box of the model may be divided by predetermined intervals, and then, a center point of each of the divided areas may be set as a support generation position.

In addition, at the thermal data change amount collection step, when a support positioned at the center of a divided area is set as a heat discharge responsible area that is responsible for discharging heat from an output model, a temporary support for analyzing heat dissipation rather than a real support for outputting may be generated, and then, thermal data simulation results of the output model may be collected.

Specifically, when thermal data simulation results of the output model are collected at the thermal data change amount collection step, thermal data of each layer within a heat discharge responsible area which is covered by each temporary support may be derived (S440), the model and the temporary support area may be separated (S450), and then, a maximum residual heat data value and a minimum residual heat data value within the area may be calculated (S460).

FIG. 6 is a view provided to explain the thermal data change amount analysis step in detail according to an embodiment of the disclosure, and FIG. 7 is a view illustrating a linear heat discharge graph according to an embodiment of the disclosure.

Referring to FIG. 6, at the thermal data change amount analysis step, when a heat discharge range for collecting thermal data is present (S610—Yes), a linear heat discharge graph may be generated based on maximum residual heat data and minimum residual heat data which are calculated within each heat discharge responsible area as shown in FIG. 7 (S620), and feature points of each heat discharge range may be derived with reference to the generated linear heat discharge graph (S630).

At the thermal data change amount analysis step, when feature points of each heat discharge range are derived, differences between the derived feature points and the linear heat discharge graph may be calculated (S640), and the differences calculated according to each output direction may be normalized and added (S650).

That is, at the thermal data change amount analysis step, the differences calculated according to each output direction may be normalized, and values of the normalized sum may be compared (S660). In this case, results of normalizing and adding according to each output direction may be compared, and an output direction that has a relatively smaller value than the other output directions may be determined as an output direction having a relatively good heat dissipation characteristic.

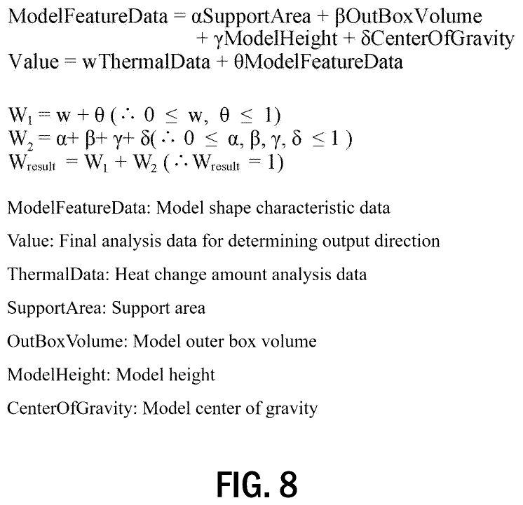

FIG. 8 is a view provided to explain a weighting which is applied when final analysis data for determining an output direction is derived according to an embodiment of the disclosure.

When a weighting on a shape characteristic parameter is determined according to a user input at the initial user setting step, the determined weighting may be applied when final analysis data for determining an output direction is derived at the thermal data change amount analysis step.

Specifically, a result value (Value) of final analysis data for determining an output direction may be calculated by Equation 4 presented below, when α, β, γ, δ, ω, θ are weightings that are given to respective shape characteristics, a final weighting (Wresult) is a sum of a first weighting (W1) and a second weighting (W2), the first weighting (W1) is defined by Equation 1 presented below, the second weighting (W2) is defined by Equation 2 presented below, and ModelFeatureData is defined by Equation 3 presented below:

$${W}_{1} = w + θ ( ∴ 0 \leq w , θ \leq 1 ) \qquad Equation 1$$

$${W}_{2} = α + β + γ + δ ( ∴ 0 \leq α , β , γ , δ \leq 1 ) \qquad Equation 2$$

$$ModelFeatureData = α SupportArea + β OutBoxVolume + γ ModelHeight + δ CenterOfGravity \qquad Equation 3$$

$$Value = wThermalData + θ ModelFeatureData \qquad Equation 4$$

where ThermalData is heat change amount analysis data, ModelFeatureData is shape characteristic data of a model, SupportArea is a size of a support area, OutBoxVolume is a volume of an outer box of a model, ModelHeight is a height of a model, CenterOfGravity is a center of gravity of a model.

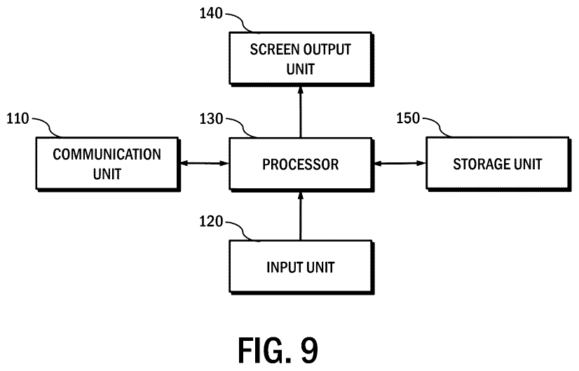

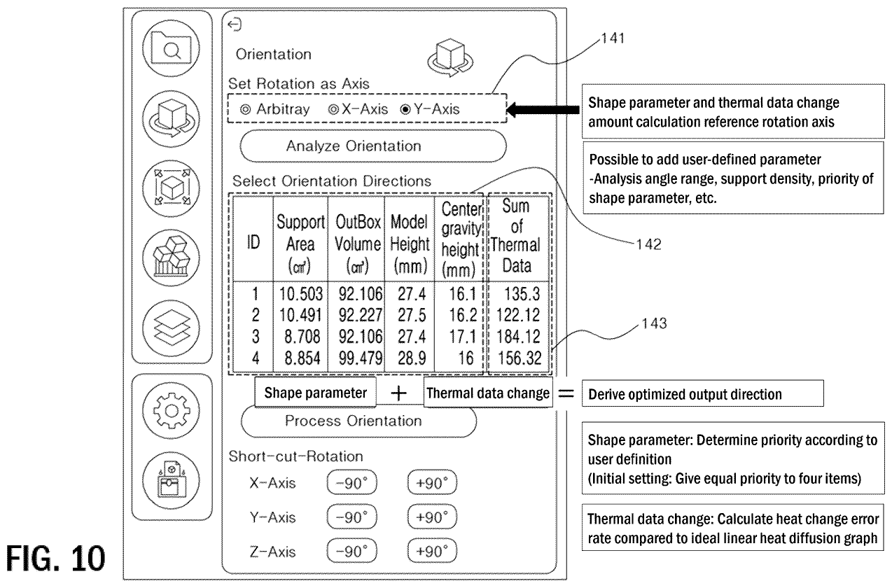

FIG. 9 is a view provided to explain a heat dissipation characteristic analysis-based model output direction determination system according to an embodiment of the disclosure, and FIG. 10 is a view illustrating a screen which is outputted through a screen output unit according to an embodiment of the disclosure.

The heat dissipation characteristic analysis-based model output direction determination system according to the present embodiment may execute the heat dissipation characteristic analysis-based model output direction determination method described above with reference to FIGS. 3 to 8.

Referring to FIG. 9, the heat dissipation characteristic analysis-based model output direction determination system may include a communication unit 110, an input unit 120, a processor 130, an output unit 140, and a storage unit 150.

The communication unit 110 may be a means for communicating with external devices including a 3D printer and connecting to a server, a cloud, etc. through a network, and may transmit/receive/upload/download data necessary for 3D printing.

The input unit 120 may be a means for receiving an input such as the number of reference rotation axes (X, Y, Z axes) for analyzing, an output direction angle range and a degree of a unit angle which are to be analyzed. In addition, the input unit 120 may receive an input of a parameter, etc. for setting equipment of a 3D printer.

The storage unit 150 is a storage medium that provides a storage space necessary for normally operating the processor 130.

The processor 130 may perform the heat dissipation characteristic analysis-based model output direction determination method described above with reference to FIGS. 3 to 8.

Specifically, the processor 130 may calculate a shape characteristic of a model according to an output direction of the model which changes in an outputting process of metal 3D printing, may collect simulation results for residual heat data of the model every time the output direction changes, may analyze heat dissipation characteristics within the model, based on the collected simulation results, may calculate heat flatness after heat dissipation with respect to each output direction, based on the result of analyzing heat dissipation characteristics, and may recommend output directions in descending order of heat flatness remaining in the model through the screen output unit 140.

The screen output unit 140 is a display that outputs information generated/processed by the processor 130 to a screen. Specifically, the screen output unit 140 may output the result of recommending output directions through the screen.

Referring to FIG. 10, the screen output unit 140 may include a rotation axis selection region 141, a shape parameter output region 142, and a thermal data output region 143.

The rotation axis selection region 141 is a region where data inputted by a user for a reference rotation axis which is used for calculating a shape parameter, a thermal data change amount is outputted.

The shape parameter output region 142 is a region where an analysis angle range, a support density, a priority of a shape parameter which are defined (set) by a user input are outputted.

The thermal data output region 143 is a region where a result of calculating a heat change error rate compared to an ideal linear heat diffusion graph is outputted.

Through this, a user may select an optimized output direction, based on results outputted to the shape parameter output region 142 and the thermal data output region 143.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A heat dissipation characteristic analysis-based model output direction determination method comprising:
a shape characteristic parameter deriving step of calculating, by a model output direction determination system, shape characteristic data of a model according to an output direction of the model which changes in an outputting process of metal 3D printing;
a thermal data change amount collection step of collecting, by the model output direction determination system, simulation results regarding residual heat data of the model every time the output direction changes;
a thermal data change amount analysis step of analyzing, by the model output direction determination system, heat dissipation characteristics within the model, based on the collected simulation results, and calculating heat flatness after heat dissipation with respect to each output direction; and
an output direction determination step of recommending, by the model output direction determination system, output directions in descending order of heat flatness remaining within the model, based on the result of calculating heat flatness after heat dissipation with respect to each output direction at the thermal data change amount analysis step.

2. The heat dissipation characteristic analysis-based model output direction determination method of claim 1, wherein the shape characteristic parameter deriving step comprises calculating shape characteristic data including a size of a support area, a volume of an outer box, a height, a center of gravity of the model with respect to each output direction according to a changing output direction.

3. The heat dissipation characteristic analysis-based model output direction determination method of claim 1, further comprising an initial user setting step of setting, by the model output direction determination system, at least one rotation axis of an X-axis, a Y-axis, and a Z-axis as a reference rotation axis for analyzing according to a user input, and setting an output direction angle range and a unit angle which are to be analyzed.

4. The heat dissipation characteristic analysis-based model output direction determination method of claim 3, wherein the initial user setting step comprises determining an amount of calculation for analyzing heat dissipation according to the number of reference rotation axes, a range of an angle, and a degree of a unit angle which are set.

5. The heat dissipation characteristic analysis-based model output direction determination method of claim 1, wherein the thermal data change amount collection step comprises:
a step of, when the output direction changes and a shape of an outer box changes, dividing an area of a lower end of the changed outer box by predetermined intervals, and then setting a divided area as an area responsible for discharging heat;
a step of setting a center point of a divided area as a generation position of a temporary support for analyzing heat dissipation, and generating a temporary support at the set generation position; and
a step of collecting thermal data simulation results of an output model.

6. The heat dissipation characteristic analysis-based model output direction determination method of claim 5, wherein the step of collecting the thermal data simulation results of the output model comprises:
a step of deriving thermal data of each layer within the heat discharge responsible area which is covered by each temporary support;
a step of separating the model and the temporary support area; and
a step of calculating a maximum residual heat data value and a minimum residual heat data value within an area.

7. The heat dissipation characteristic analysis-based model output direction determination method of claim 6, wherein the thermal data change amount analysis step comprises:
a step of generating a linear heat discharge graph based on the maximum residual heat data and the minimum residual heat data which are calculated within each heat discharge responsible area;
a step of deriving feature points of each heat discharge range with reference to the generated linear heat discharge graph;
a step of calculating differences between the derived feature points and the linear heat discharge graph; and
a step of normalizing and adding the calculated differences according to each output direction.

8. The heat dissipation characteristic analysis-based model output direction determination method of claim 7, wherein the thermal data change amount analysis step comprises comparing the results of normalizing and adding according to each output direction, and determining an output direction that has a relatively smaller value than the other output directions as an output direction having a relatively good heat dissipation characteristic.

9. The heat dissipation characteristic analysis-based model output direction determination method of claim 8, wherein the thermal data change amount analysis step comprises applying a weighting inputted by a user when deriving final analysis data for determining an output direction,
wherein a result value (Value) of the final analysis data for determining the output direction is calculated by Equation 4 presented below, when ThermalData is heat change amount analysis data, ModelFeatureData is shape characteristic data of a model, SupportArea is a size of a support area, OutBoxVolume is a volume of an outer box of a model, ModelHeight is a height of a model, CenterOfGravity is a center of gravity of a model, α, β, γ, δ, ω, θ are weightings that are given to respective shape characteristics, a final weighting (Wresult) is a sum of a first weighting (W1) and a second weighting (W2), the first weighting (W1) is defined by Equation 1 presented below, the second weighting (W2) is defined by Equation 2 presented below, and ModelFeatureData is defined by Equation 3 presented below:
$${W}_{1} = w + θ ( ∴ 0 \leq w , θ \leq 1 ) \qquad Equation 1$$
$${W}_{2} = α + β + γ + δ ( ∴ 0 \leq α , β , γ , δ \leq 1 ) \qquad Equation 2$$
$$ModelFeatureData = α SupportArea + β OutBoxVolume + γ ModelHeight + δ CenterOfGravity \qquad Equation 3$$
$$Value = wThermalData + θ ModelFeatureData . \qquad Equation 4$$

10. A heat dissipation characteristic analysis-based model output direction determination system comprising:
a processor configured to calculate shape characteristic data of a model according to an output direction of the model which changes in an outputting process of metal 3D printing, to collect simulation results for residual heat data of the model every time the output direction changes, to analyze heat dissipation characteristics within the model, based on the collected simulation results, to calculate heat flatness after heat dissipation with respect to each output direction, and to recommend output directions in descending order of heat flatness remaining in the model based on the result of calculating; and
a screen output unit configured to output the result of recommending output directions to a screen.

11. A non-transitory computer-readable storage medium storing instructions that, when executed by a processor, configure the processor to perform the method of claim 1.

12. A heat dissipation characteristic analysis-based model output direction determination method comprising:
a thermal data change amount collection step of collecting, by a model output direction determination system, simulation results regarding residual heat data of a model every time an output direction changes in an outputting process of metal 3D printing;
a thermal data change amount analysis step of analyzing, by the model output direction determination system, heat dissipation characteristics within the model, based on the collected simulation results, and calculating heat flatness after heat dissipation with respect to each output direction; and
an output direction determination step of recommending, by the model output direction determination system, output directions in descending order of heat flatness remaining within the model, based on the result of calculating heat flatness after heat dissipation with respect to each output direction at the thermal data change amount analysis step.
